(19) United States
(12) Patent Application Publication
(10) Pub. No.: US 2021/0094641 A1
(43) Pub. Date: Apr. 1, 2021

(54) BICYCLE SADDLE

(71) Applicant: Mu-Rong Li, TAICHUNG CITY (TW)

(72) Inventor: Mu-Rong Li, TAICHUNG CITY (TW)

(21) Appl. No.: 16/584,963

(22) Filed: Sep. 27, 2019

(51) Int. Cl. B62J 1/00

(52) U.S. Cl. CPC B62J 1/002

(57) ABSTRACT

A bicycle saddle includes a body having a padding portion and an underside portion. The body includes a front portion and a rear portion. The front portion has a restriction plate connected to the underside portion of the body. A first recess is formed between the restriction plate and the front portion. Two protrusions extend from the underside portion of the rear portion. A second recess is formed in each of the protrusions. A rail unit is connected to the underside portion of the body and includes two rails. Two respective first ends of the two rails are connected to a front connection part. The front connection part of the rail unit is connected to the first recess by adherent. Each rail has a rear connection part formed to the second end thereof The two respective rear connection parts are respectively secured in the two second recesses by another adherent.

### BACKGROUND OF THE INVENTION

### 1. Fields of the Invention

The present invention relates to a bicycle saddle, and more particularly, to a bicycle saddle that is easily assembled and has strong structural strength.

### 2. Descriptions of Related Art

The conventional bicycle saddles vary mostly in terms of width for adults. Racing saddles are narrower, and comfort saddles are wider. In order to reduce the saddle weight and to provide comfort to the users, many different materials and structure manufacturers increase thickness of the saddles, and some manufacturers make the bicycle saddles with holes and reduce widths for the saddles.

The present invention intends to provide a bicycle saddle that is designed to be simple and easily assembled, while providing comfort and strength.

### SUMMARY OF THE INVENTION

The present invention relates to a bicycle saddle and comprises a body having a padding portion and an underside portion. The body includes a front portion and a rear portion. The front portion has a restriction plate connected to the underside portion of the body. A first recess is formed between the restriction plate and the front portion. Two protrusions extend from the underside portion of the rear portion. A second recess is formed in each of the protrusions. A rail unit is connected to the underside portion of the body and has two rails. Two respective first ends of the two rails are connected to a front connection part. The front connection part of the rail unit is connected to the first recess. Each rail has a rear connection part formed to the second end thereof The two respective rear connection parts are respectively secured in the two second recesses by adherent.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle saddle of the present invention;

FIG. 2 is an exploded view to show the bicycle saddle of the present invention;

FIG. 3 shows that the front connection part of the rail unit is to be connected with first recess of the body of the bicycle saddle of the present invention;

FIG. 4 shows that the rear connection parts of the rail unit are to be connected with the second recesses of the body of the bicycle saddle of the present invention;

FIG. 5 shows that the two rails are pushed toward each other before being connected with the second recesses of the body of the bicycle saddle;

FIG. 6 shows that the rail unit is connected to the body of the bicycle saddle;

FIG. 7 is a cross sectional view, taken along line VII-VII of FIG. 6;

FIG. 8 is a cross sectional view, taken along line VIII-VIII of FIG. 6;

FIG. 9 is an enlarged view to show the rear connection part of the rail unit and the second recess of the body, and

FIG. 10 is a cross sectional view, taken along line X-X of FIG. 6.

### DETAILED DESCRIPTION OF THE PREFERRED EMBODIMENT

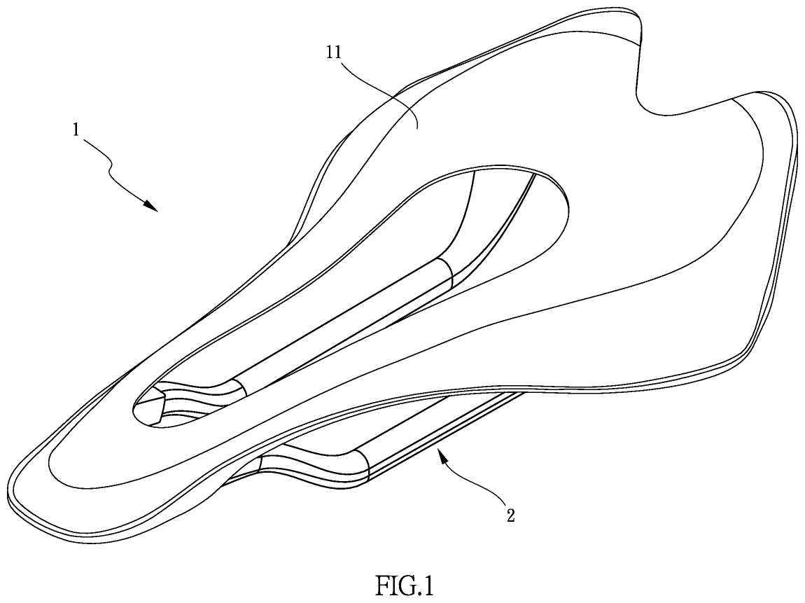

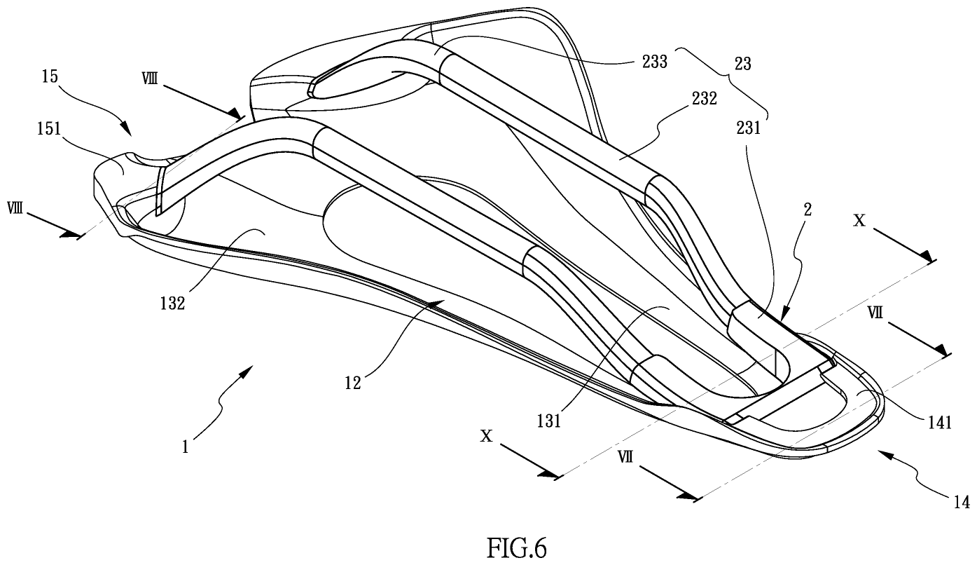

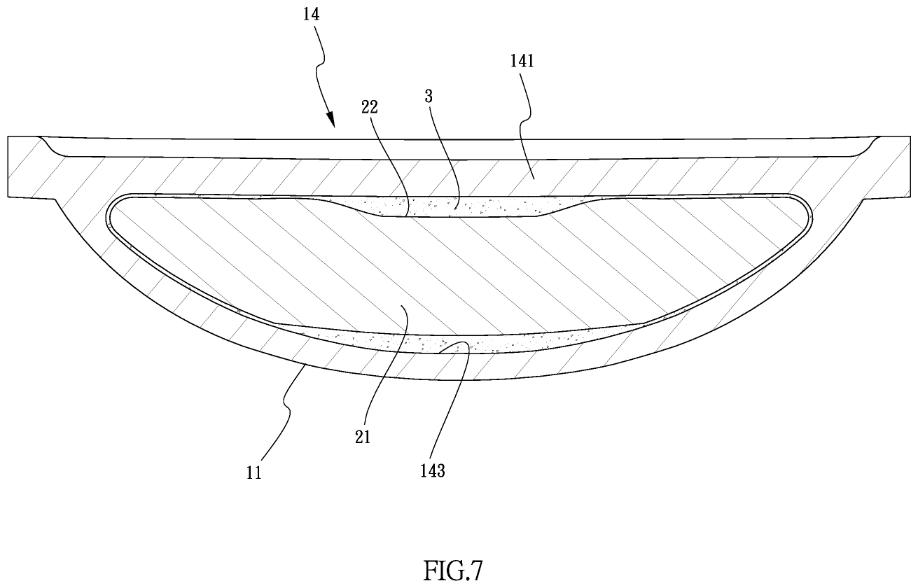

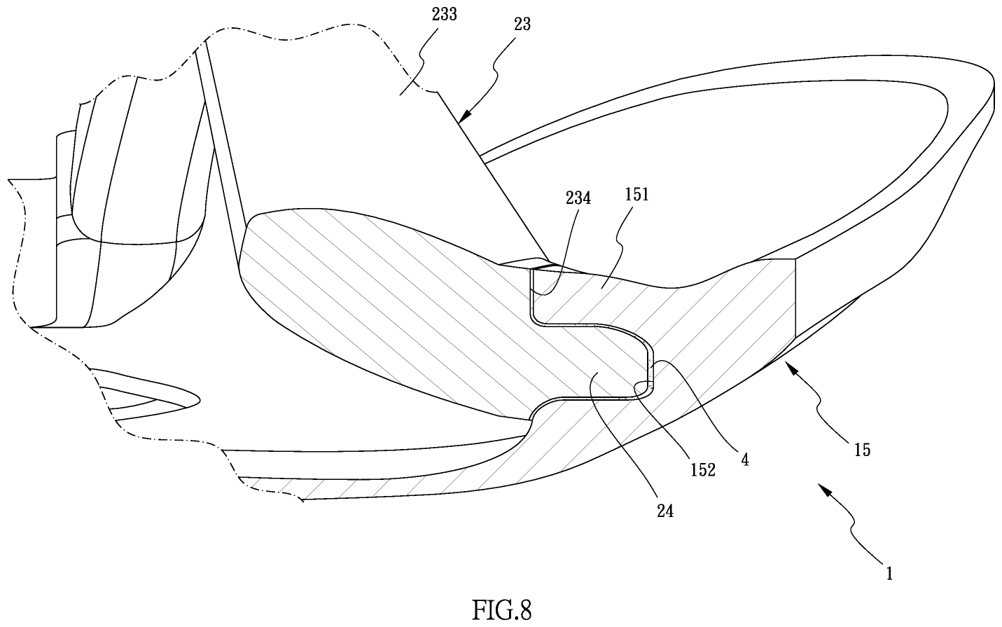

Referring to FIGS. 1, 2, 6, 7 and 8, the bicycle saddle of the present invention comprises a body 1 having a padding portion 11 and an underside portion 12, and an opening is defined through the padding portion 11 of the body 1. The body 1 has a front portion 14 and a rear portion 15, wherein the from portion 14 has a u-shaped restriction plate 141 connected to the underside portion 12 of the body 1, and a first recess 143 is formed between the restriction plate 141 and the front portion 14. Two protrusions 151 extend from the underside portion 12 of the rear portion 15. A second recess 152 is formed in each of the protrusions 151. Specifically, the underside portion 12 of the body 1 includes a recessed area 13 which includes a front area 131 and a rear area 132. The front area 131 is located at the front portion 14 of the body 1, and the rear area 132 is located at the rear portion 15 of the body 1. The two protrusions 151 protrude from the rear area 132. The second recesses 152 each face to the first recess 143 corresponding thereto.

A rail unit 2 is connected to the underside of the body 1 and includes two rails 23. Two respective first ends of the two rails 23 are connected to a front connection part 21. The front connection part 21 of the rail unit 2 is connected to the first recess 143. Each rail 23 has a rear connection part 24 formed to the second end thereof The two respective rear connection parts 24 are respectively secured in the two second recesses 152 by a first adherent 4.

Specifically, the front connection part 21 of the rail unit 2 includes a notch 22 in which s second adherent 3 is filled, so that the front connection part 21 of the rail unit 2 is connected to the first recess 143 by the second adherent 3.

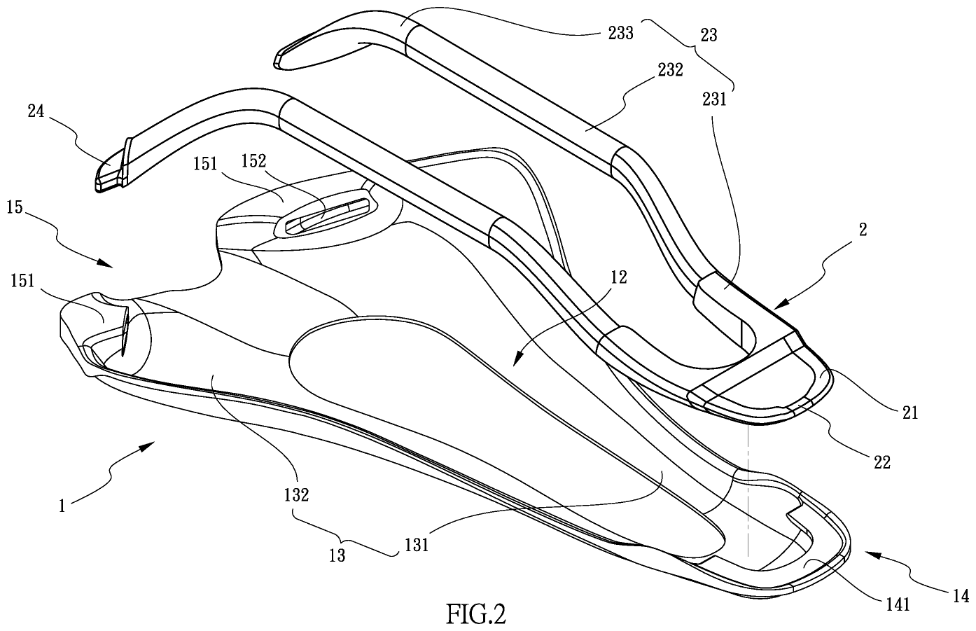

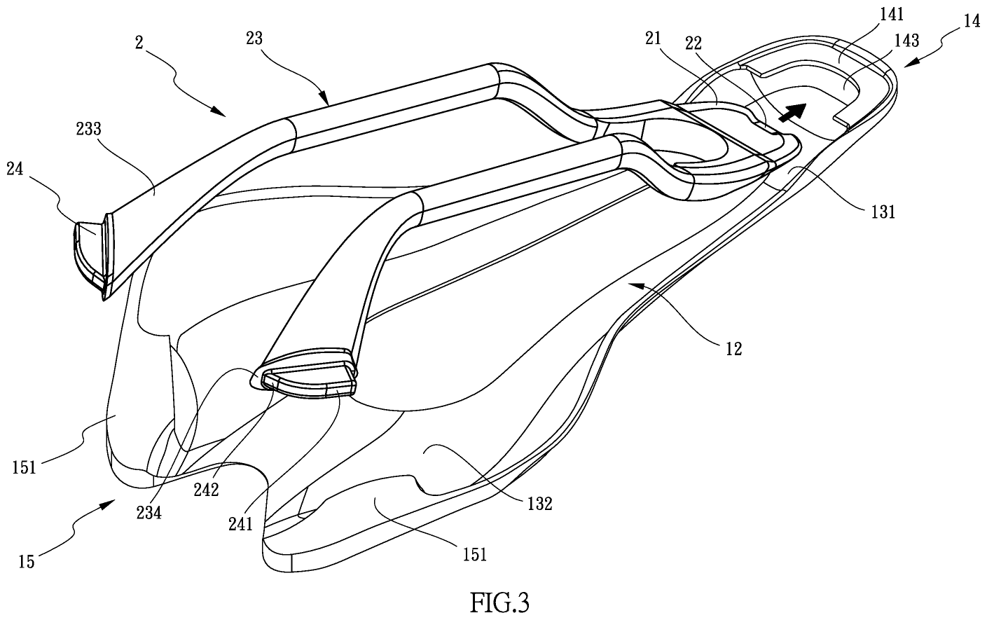

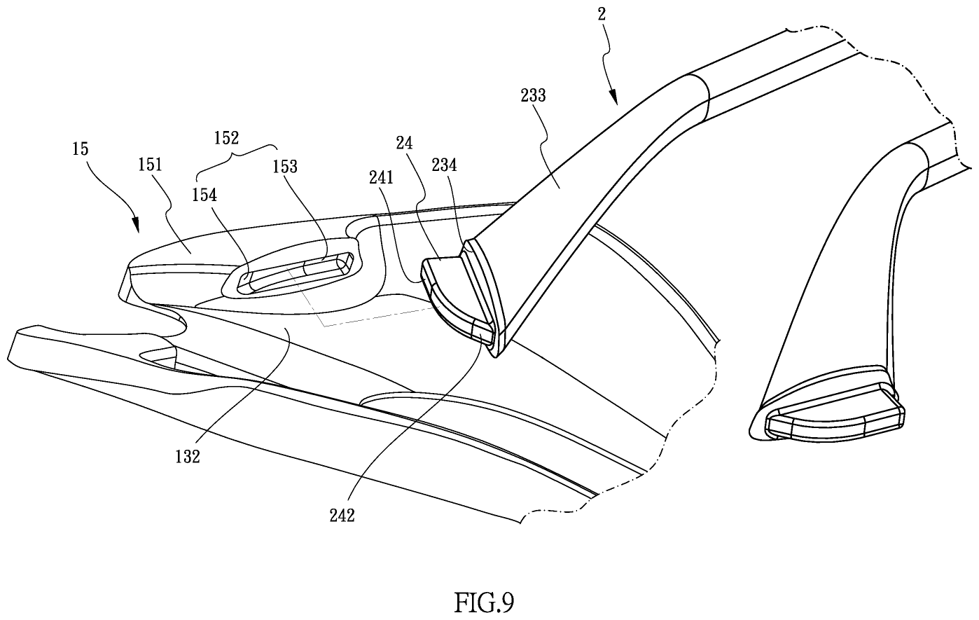

The two rails 23 each include a first section 231, a second section 232 and a third section 231 wherein the second section 232 is formed between the first section 231 and the third section 233. Each of the first and third sections 231, 233 is bent an angle relative to the second section 232 and extend toward the body 1 as shown in FIG. 2. The two respective third sections 233 each have the rear connection part 24 formed thereto. Specifically, the rear connection part 24 extends from a connection face 234 formed on the distal end of the third section 233 corresponding thereto. The rear connection part 24 includes an end face 241 and an inclined face 242 as shown in FIGS. 3 and 9. Each second recess 152 includes an inner bottom 153 and an inclined wall 154 as shown in FIG. 2.

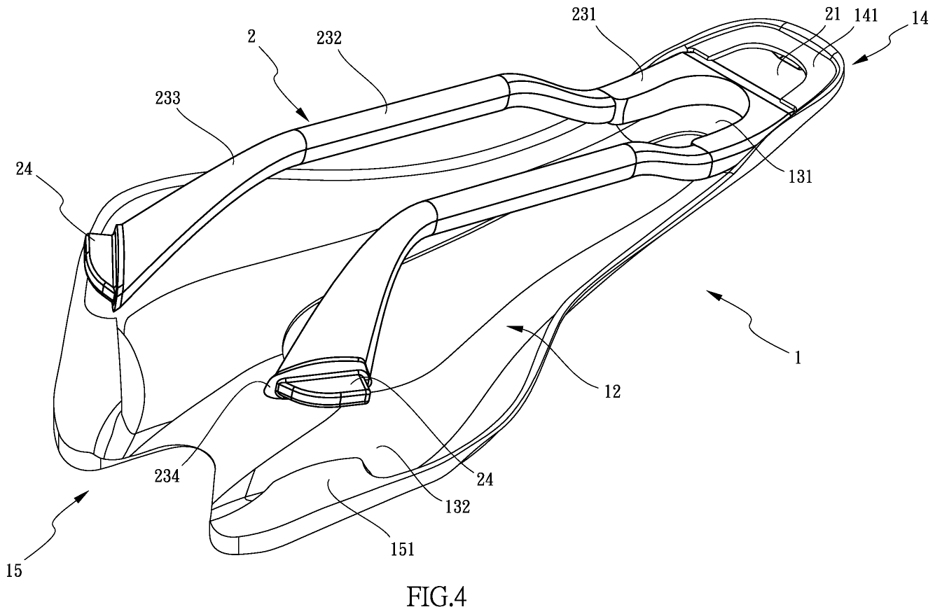

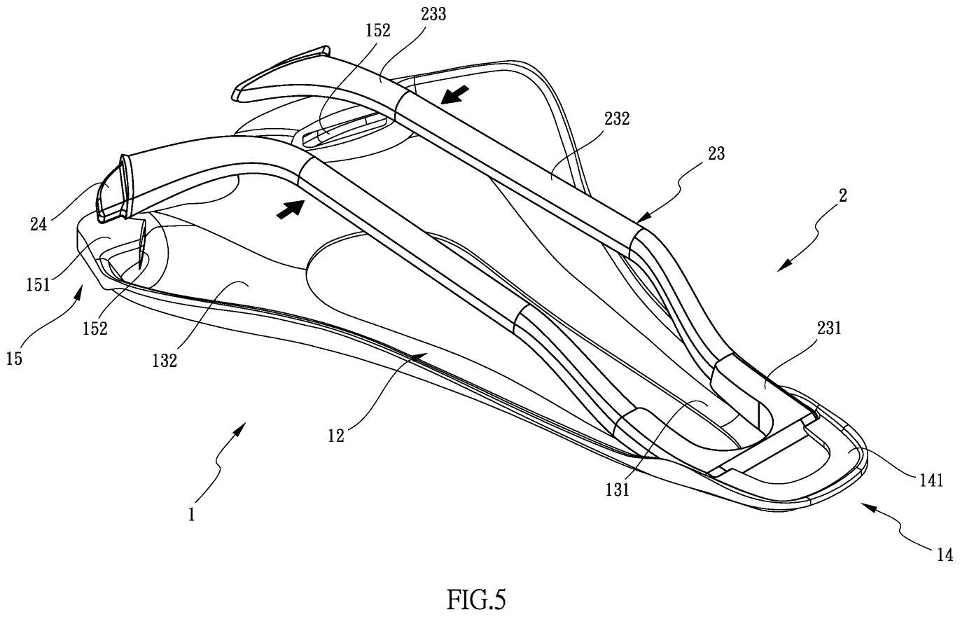

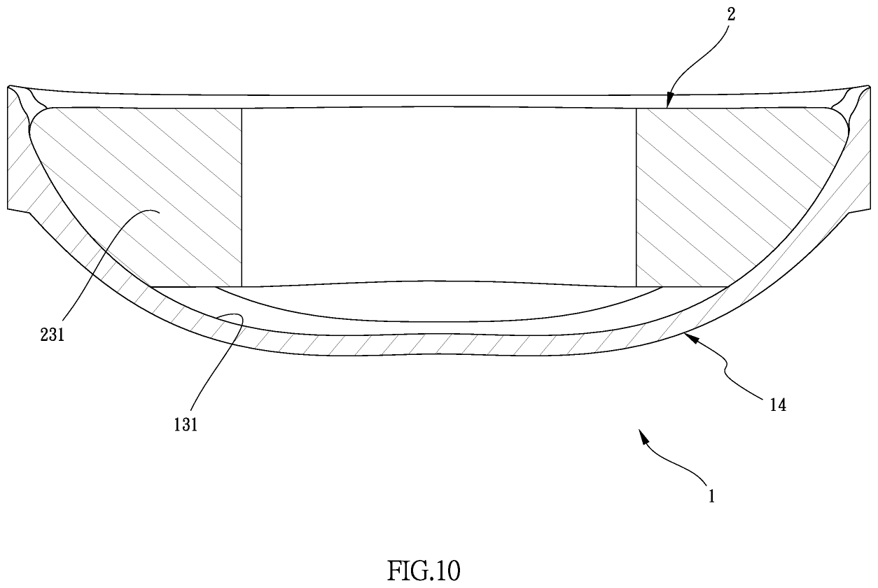

When installing the rail unit 2 to the body 1, as shown in FIGS. 2 to 6, the front connection part 21 is inserted into the first recess 143 and secured to the first recess 143 by the second adherent 3, and the two rails 23 are pushed toward each other so as to located the two rails 23 at the area of the underside portion 12. The two respective first section 231 of the two rails 23 respectively contact the inside wall of the front area 131 of the body 1 as shown in FIG. 10.

The two rear connection parts 24 are then inserted into the second recesses 152, wherein the end face 241 of the rear connection part 24 is glued to the inner bottom 153 of the second recess 152 corresponding thereto by the first adherent 4, and the inclined face 242 of the rear connection part 24 is glued to the inclined wall 154 of the second recess 152 corresponding thereto by the first adherent 4.

While we have shown and described the embodiment in accordance with the present invention, it should be clear to those skilled in the art that further embodiments may be made without departing from the scope of the present invention.

What is claimed is:

1. A bicycle saddle comprising:
a body having a padding portion and an underside portion, the body having a front portion and a rear portion, the front portion having a restriction plate connected to the underside portion of the body, a first recess being formed between the restriction plate and the front portion, two protrusions extending from the underside portion of the rear portion, a second recess being formed in each of the protrusions, and
a rail unit having two rails, two respective first ends of the two rails connected to a front connection part, the front connection part of the rail unit connected to the first recess, each rail having a rear connection part formed to a second end thereof the two respective rear connection parts respectively secured in the two second recesses by a first adherent.

2. The bicycle saddle as claimed in claim 1, wherein the front connection part of the rail unit is secured in the first recess by a second adherent.

3. The bicycle saddle as claimed in claim 2, wherein the front connection part of the rail unit includes a notch in which the second adherent is filled.

4. The bicycle saddle as claimed in claim 1, wherein the second recesses each face to the first recess.

5. The bicycle saddle as claimed in claim wherein the underside portion of the body includes a recessed area which includes a front area and a rear area, the front area is located at the front portion of the body and the rear area is located at the rear portion of the body, the two protrusions protrude from the rear area, the two rails each include a first section, a second section and a third section, the second section is formed between the first section and the third section, each of the first and third sections is bent an angle relative to the second section, the two respective first section respectively contact an inside wall of the front area of the body, the two respective third sections each have the rear connection part formed thereto.

6. The bicycle saddle as claimed in claim 5, wherein the rear connection part extends from a connection face formed on a distal end of the third section corresponding thereto, the rear connection part includes an end face and an inclined face, each second recess includes an inner bottom and an inclined wall, the end face of the rear connection part is located corresponding to the inner bottom of the second recess corresponding thereto, the inclined face of the rear connection part is located corresponding to the inclined wall of the second recess corresponding thereto.
